(19) United States
(12) Patent Application Publication
(10) Pub. No.: US 2013/0269623 A1
(43) Pub. Date: Oct. 17, 2013

(54) WOOD ANIMAL LITTER

(71) Applicant: Frederick LAWSON, Somerset, NJ (US)

(72) Inventor: Frederick LAWSON, Somerset, NJ (US)

(73) Assignee: CHURCH & DWIGHT CO., INC., Princeton, NJ (US)

(21) Appl. No.: 13/448,566

(22) Filed: Apr. 17, 2012

(51) Int. Cl. A01K 1/015; A01K 29/00

(52) U.S. Cl. 119/171

(57) ABSTRACT

The present invention is directed toward an animal litter and its method of making, comprising one or more wood substrates, one or more clumping agents and one or more adhering agents, wherein the animal litter is dense, resulting in less tracking and scattering when used by cats.

### FIELD OF THE INVENTION

The present invention relates to animal litters, and in particular to clumpable animal litters that are based on wood materials.

### BACKGROUND OF THE INVENTION

Various methods and compositions are known that utilize absorbent materials in litter boxes and animal cages in an effort to efficiently and effectively collect animal urine and/or feces. In particular, clays (primarily bentonite) have been used as a base material for absorbent animal litters for some time. These materials become tacky when wetted, thereby forming a “clump” that is easily removed from a litter box. Many animals, especially felines, will often refuse to use a litter box that is not kept scrupulously clean. Clumpable animal litters facilitate the ease of cleaning, because otherwise the litter box has to be periodically dumped and refilled to maintain appropriate cleanliness.

An important disadvantage of clay-based litters is that they aggressively stick to the sides and bottom of the litter pan when wetted. This tendency makes removal of the clumped litter more difficult, which partially defeats the purpose of the clumping action. Moreover, the animal urine odor often becomes impregnated in the plastic or other porous or semi-porous material from which the litter box is formed. Therefore, litter that is stuck to the sides and bottom of the litter pan requires more frequent replacement of the litter box itself. It would thus be desirable to develop a litter material that results in “softer” clumps, that is, clumps that stick together sufficiently for removal from the litter pan but that do not stick as easily to the sides and bottom of the litter pan.

A secondary concern is the environmental impact from the production and usage of the clay-based litters. Clay materials such as bentonite are mined and then further processed with additives to be packaged for the market as animal litter. Clumps of clay do not readily break down in water and may clog household plumbing. Furthermore, clays contain silica, a known carcinogen. Thus, the use of silica containing compounds raises health concerns for both the animals and the individuals who come in contact with the litter.

It has been recognized that a litter based on wood substrates rather than clays would be highly desirable. Wood substrates, such as sawdust and lumber mill scraps, wasted paper, pulp and husks are readily available and inexpensive. Some of these substrates are more absorbent than clay materials, and naturally contain chemicals that will neutralize odor. Wood substrates may be formed into pelletized shapes with a pellet mill.

However, a significant drawback of wood substrates is that litters based on wood materials have historically lacked the highly desirable clumping feature of clay litters. Attempts to develop clumping wood litters have been unsuccessful due to inferior production techniques, and the high cost of the various ingredients needed to create the clumping action in a wood-based litter.

There are numerous known animal litter compositions that are based on wood substrates. One example is U.S. Pat. No. 5,970,916 to Yoder et al., which teaches clumping cellulosic animal litter comprising a cellulosic substrate that is coated with multiple gum layers that are bonded by water coatings.

Another example is U.S. Pat. No. 7,124,710 to Weaver, which teaches a clumping cellulosic animal litter comprising a cellulosic base material, a surfactant and carboxymethylcellulose as a clumping agent.

Another example is U.S. Pat. No. 6,053,125 to Kory et al., which teaches an animal litter comprising a mixture of heavy density particles and light density particles. The heavy density particles are formed of corncob grit and the light density particles are formed of pelletized lightweight corncob components. Heavy density and light density particles are coated with mineral oil to which guar gum is adhered.

Another example is U.S. Pat. No. 5,152,250 to Leob, which teaches an animal litter that includes a biodegradable carrier such as granulated peanut shells having grain flour intermixed therewith and attached thereto with oil.

Another example is U.S. Pat. No. 5,927,049 to Simard, which teaches an animal litter comprising yellow pine wood pellets.

The remaining examples are U.S. Pat. Nos. 7,331,309; 7,527,019; and 7,856,946 to Burckbuchler Jr., which teach a clumping litter comprising a combination of anionic polyacylamide, a guar gum, grist and cellulosic materials.

While much of the prior art discloses the use of wood cellulosic sources as a preferred or alternative embodiment, few manufactures have been able to create a cellulosic particulate litter that is economical to produce. These cellulosic animal litters are expensive to fabricate, as they are often difficult to manufacture. For example, wood-based litters typically require multiple applications of aqueous additives (e.g. biocides, deodorizers, pesticides, mold inhibitors and the like), followed by a drying step in order to create litters with the desired properties. Moreover, cellulosic litters are known to be of lower density, which means that smaller useful quantities of such litter can be packaged and shipped, as compared to conventional litter that is packaged and shipped in the same containers.

Thus, what is lacking in the prior art is a wood-based clumping animal litter with superior absorbance and enhanced clumping properties, so that it remains intact under mechanical stress, and yet is still economical to produce and inhibits mold growth. Ideally, the animal litter composition would use industrial or agricultural byproducts, thereby providing economical and environmentally friendly litters that can be readily dispersed when disposed into the household plumbing system. It is also desirable to have an animal litter composition that is compacted to reduce tracking and scattering by animals.

### SUMMARY OF THE INVENTION

The present invention is directed to an animal litter and its method of making, comprising one or more wood substrates, one or more clumping agents and one or more adhering agents.

### DETAILED DESCRIPTION OF THE INVENTION

The present invention is directed to a particulate animal litter and its method of making, comprising one or more wood substrates, one or more gum-based clumping agents and one or more adhering agents. The animal litter is compacted, degradable, highly absorbent, clumpable and dustless.

### Wood Substrates

One or more wood substrates can be used as the base material within the litter. The wood substrate is in the form of wood fibers, wood shavings, wood chips or combinations thereof. Preferably, the wood substrate is in the form of wood shavings or chips that are derived from softwoods such as cedars and trees that belong to the genus Pinus. The softwoods are preferably Southern Yellow Pine, Lodgepole Pine and Cedar. Southern Yellow Pine wood shavings are most preferred because Southern Yellow Pine has inherent odor neutralizing properties that eliminate volatile odors (e.g., mercaptan, amines, skatole gases) emitted from animal waste, without the need for additional artificial additives. Furthermore, Southern Yellow Pine shavings can be obtained cheaply from lumber mills. The wood substrate is present in the litter in the amount of at least 60 wt. %, preferably at least 75 wt. %, and more preferably at least 90 wt. % of the animal litter.

### Clumping Agents

One or more clumping agents can be used in the animal litter to make the litter clumpable. The clumping agent is a type of water-soluble galactomannan gum, such as a guar gum or a locust bean gum, or an ether derivative thereof that forms a gel upon contact with liquids (i.e., the excreted aliquot of a body fluid).

A galactomannan gum is a carbohydrate polymer that contains galactose and mannose units, or an ether derivative of such a polymer. The galactomannan gum is characterized by a linear structure of (1-4) β-D-mannopyranosyl units that have backbone containing branch points from their 6-positions linked to α-D-galactose, i.e. 1-6-linked α-D-galactopyranose. Galactomannan gums include a guar gum (with a mannose:galactose ratio of ˜2:1), which is the pulverized endosperm of the seed of either of two leguminous plants (Cyamopsis tetragonalobus and psoraloides). Also included is a locust bean gum (with a mannose:galactose ratio of ˜4:1) that is found in the endosperm of the seeds of carob trees (Ceratonia siliqua). Galactomannan gums may also include fenugreek gum (with a mannose:galactose ratio of ˜1:1) and tara gum (with a mannose:galactose ratio of ˜3:1). A preferred form of galactomannan gum is a guar gum that is commercially available from Rhone-Poulenc under the trade name Unigar 250.

Galactomannan gums that are in the form of ether derivatives and are useful in the present invention can be obtained from the guar gum or the locust bean gum, by substituting carboxyalkyl, hydroxyalkyl, or quaternary amine groups for hydroxyl functionalities in a manner known in the art. Introduction of carboxyalkyl and quaternary amine groups modifies the way in which the galactomannan gum reacts with hydrated mineral surfaces. The rate and degree of adsorption between the ether derivative and the surface can be increased or decreased. Hydroxyalkylation of the galactomannan gum decreases the affinity of the resulting ether derivative for hydrated mineral surfaces and increases the solubility of the ether derivative in water and water-miscible solvents. A preferred form of galactomannan gum is the ether derivative known as hydroxypropyl guar gum. Another preferred form of galactomannan gum is the ether derivative that is commercially available from Rhone-Poulenc under the trade designation Progacyl CP-7. Other gums such as carboxymethyl guar, carboxymethyl hydroxypropyl guar, or xantham gum are also useful.

The clumping agent is present in the animal litter in an amount of about 1 to about 10 wt. %, preferably about 3 to about 7 wt. % and more preferably about 4 to about 6 wt. % of the animal litter.

### Adhering Agent

At least one clumping agent is distributed over the surface of the wood substrate by one or more adhering agents, which are selected from oleaginous vehicles such as vegetable oil, soybean oil and mineral oil, or aqueous solutions such as diethylene glycol, triethylene glycol and propylene glycol. The adhering agent holds the clumping agent to the wood substrate, and concurrently provides dust abatement as well.

As stated hereinabove, the adhering agent can be either oleaginous, meaning oily in nature, or aqueous. Propylene glycol disperses galactomannan gum particles relatively well, but is currently rather expensive for use as a major component of the liquid vehicle. Water, by itself, is less desirable as a liquid vehicle because it does not readily dissolve galactomannan gums, especially at a relatively lower temperature. Additionally, grain or plant-based oils are less preferred, as they can undergo rancidification over time or are known as food sources for rodents. Mineral oil and blends of glycol with water are presently preferred.

If mineral oil is used, it is preferably a mixture of liquid hydrocarbons obtained from petroleum and having a specific gravity in the range of about 0.82 to about 0.95. The mineral oil is also required to be at least biodegradable 60% after 28 days in freshwater and seawater under the Organization for Economical Commercial Development (OECD) 301 and OECD 306 protocols, respectively. Furthermore, the mineral oil should be in compliance with major Pharmacopoeia and F.D.A. regulations and the EPA requirements with regard to “oil and grease” test. It also should have a Classification in, at least, category “D” under revised OCNS regulations.

The mineral oil should have a low kinetic viscosity at 40° C., because the lower the viscosity, the better the mineral oil is for use in the present invention. The mineral oil should have generally a kinetic viscosity (at 40° C.) lower limit of about 2 mm² sec⁻¹ (2 centistokes (cSt)), preferably 5 cSt, and more preferably 7.5 cSt. Generally, the upper limit Kinetic viscosity at 40° C. of the mineral oil should be about 17 cSt. The mineral oil also should have no aromatic content. It should be noted that any aromatic content of 100 ppm or less is considered to be free of aromatics. However, it is preferred that the aromatic content be less than 50 ppm, more preferably less than 30 ppm with zero aromatic content being the most desired level. The preferred commercially available mineral oils are CARNATION oil from Witco, MARCOL® 52 from Exxon, ONDINA® 3 from Shell and ECOLANE 130 from TotalFina. With regard to the above mentioned requirements of the mineral oil, the ECOLANE 130 product is the most suitable. The mineral oil is present in the amount of about 0.1 to about 2.0 wt. %, and preferably about 0.2% to about 1.0 wt. % of the animal litter.

In addition to serving the purpose of the adhering agent, the mineral oil may also dampen residual fine dust to a considerable degree and still allow for excellent free flow properties of the litter.

### Additives

When an adhering agent such as an oleaginous vehicle is used in the litter, a moderately lipophilic and non-ionic emulsifier can be added to the adhering agent. This addition facilitates the dispersion of the clumping agent throughout the oleaginous vehicle and promotes subsequent clumping of the litter. Such moderately lipophilic and non-ionic emulsifier has a hydrophile-lipophile balance (HLB) value of at least about 10, as determined by methods that are described in The Atlas HLB System, 2d Ed. (Revised), from Atlas Chemical Industries, Inc. in Wilmington, Del. (1963).

Suitable non-ionic emulsifiers are the ethoxylated alkyl phenols, such as polyoxyethylene (6) nonyl phenyl ether (HLB 10.8), polyoxyethylene (5) nonyl phenyl ether (HLB 10.0), polyoxyethylene (9) nonyl phenyl ether (HLB 13.0), and the like. Also suitable are the mixtures of oleate esters of sorbitol and sorbitol anhydrides that are condensed with ethylene oxide, such as polyoxyethylene (5) sorbitan monooleate (HLB 10.0), polyoxyethylene (20) sorbitan trioleate (HLB 11.0), polyoxyethylene (20) sorbitan monostearate (HLB 14.9), and the like. Mixtures of the foregoing and like emulsifiers can also be utilized for the present purposes.

Besides emulsifiers, one or more absorbent polymers may also be used in the litter to impart excellent absorptive capacity for aqueous media (e.g. typically upwards of 400 times of the weight of the polymer) with minimal tackiness. Suitable absorbent polymers for use in the present invention include anionic polyacrylamides, a group of high charge density, water soluble, high molecular weight macromolecules that are produced through the polymerization of acrylamide and an anionically charged co-monomer, and formed by any polymerization method known in the art. Some examples of the anionically charged co-monomers include sodium acrylate, potassium acrylate and other salts of acrylic acid and derivatives thereof known in the art.

The preferred anionic polyacrylamide is supplied under the designation CLEAROUT® P6400 (manufactured by Chemtall Inc., Ga., USA). CLEAROUT® P6400 is a fine white powder with an approximate bulk density of 0.8 and viscosities of 1800 cps at concentration of 5.0 g/L; 700 cps at concentration of 2.5 g/L; 300 cps at concentration of 1.0 g/L, (as measured by a Brookfield viscometer at 25° C.). The intrinsic viscosity (IV) is about 22 dL/g. The dissolution time of the polymer in deionized water at 5 g/L, 25° C. is 60 minutes. The polymer has about 20 to 40 mole % of anionically charged co-monomers.

The litter may also include other additives. Non-limiting examples of these additives include, but are not limited to oils or extracts of fragrances, antimicrobial agents, deodorants, disinfectants, colorants (i.e. pigments, dyes, lakes), binders such as PELLET BOND® (manufactured by Matam Corp., Indiana, USA) and combinations thereof. Other suitable additives include oxidizers, such as sodium perborate and/or calcium peroxide, to neutralize the volatile odors (i.e. mercaptan, amines, skatole gases) that are emitted from the waste. The addition of at least one of the aforementioned additives during the formation of the pellet would produce pellets that are comprised of the characteristics of the additive throughout, e.g. color, fragrance, etc. The additive, if used, is present at about 0 to about 20 wt. % of the litter mixture.

### Method of Production

Initially, the wood substrate is dried prior to use. For example, wood shavings are dried and cured in a kiln at about 120° F. to 200° F. for a period of time until the shavings reach a uniform moisture content that is preferably between 8 and 10%. A hammer mill grounds the dried substrate to form grist of uniform consistency. The grist is uniform, evenly compressible to hold a fixed shape. The grist is sprayed with water in the form of either mist or steam for approximately 3-4 seconds to form grist having uniform moisture content. The moistened grist is then pelletized in a pellet mill. During the pelletization process, the moistened grist is exposed to increased pressure and temperature for a short period of time. More specifically, the moistened grist is pressurized at about 60 Kpsi for approximately 4 to 10 seconds in the temperature range of about 180° F. to about 250° F. The pellets are subsequently cooled to an ambient temperature. This cooling step advantageously allows the pellets to coalesce before further processing. The pellets are further crushed or milled in a roller mill, a hammer mill, or other milling devices. The crushed pellets are sieved to obtain pellets that have the size of −4 m, +100 m U.S. screen size, preferably −8 m, +40 m U.S. screen size. The oversized materials are circulated back to the mill and the fines are re-pelletized.

The collected reduced-size pellets are blended with one or more clumping agents in a rotary or other suitable blender, and one or more adhering agents is subsequently sprayed onto the mixture. Alternatively, the pellets are first sprayed with one or more adhering agents then mixed with one or more clumping agents in a rotary blender. Another convenient method for preparing the animal litter is to first create a suspension of one or more clumping agents with one or more adhering agents, then distribute the resulting suspension over the pellets. In yet another convenient method of preparing the animal litter, the pellets are dipped into a suspension of one or more clumping agents with one or more adhering agents, or rolled in a drum that contains a relatively small amount of the suspension. The suspension is substantially and uniformly distributed over the pellets in the form of a coating or surface layer, but it need not completely cover the entire surface of any pellets. Additionally, the adhering agent penetrates marginally into the surface of the pellets, but the penetration does not adversely affect the absorption and liquid retention capabilities of the pellets.

The mixture of wood pellets, one or more clumping agents and one or more adhering agents should be mixed for at least three minutes to completely attach the clumping agent to the pellets. The resulting litter has the pellets distributed throughout, and has a uniform density of about 15 to about 45 lb/ft³, preferably about 20 to about 40 lb/ft³ and more preferably about 25 to about 30 lb/ft³. The litter mixture is then packaged into cartons or polyethylene or the like lined bags to prevent absorption of moisture, and sold for household use. The pellets within the litter maintain their natural scent.

### EXAMPLE

Southern Yellow Pine shavings, guar gum, and anionic polyacrylamide were mixed according to the above-mentioned method minus the pelleting steps to produce a comparative formulation from the prior art, wherein the litter particles have a density of 12-13 lb/ft³. Meanwhile, an inventive formulation was made according to the above-mentioned method of production with Southern Yellow Pine pellets, guar gum and mineral oil. The inventive litter has the pellets distributed throughout and has a uniform density of 25-30 lb/ft³. The inventive litter is twice as dense as the comparative litter, resulting in less tracking and scattering when used by cats.

| | |
|---|---|
| Comparative | Inventive |
| Formulation | Formulation |

| | | | |
|---|---|---|---|
| Screened Southern Yellow | 93.665 | wt. % | N/A |
| Pine shavings | | | |

| | | | |
|---|---|---|---|
| Crushed & Screened | N/A | 95.0 | wt. % |
| Southern Yellow Pine Pellets | | | |

| | | | | |
|---|---|---|---|---|
| Guar Gum | 6.1 | wt. % | 4.5 | wt. % |

| | | | |
|---|---|---|---|
| Anionic polyacrylamide | 0.235 | wt. % | N/A |

| | | | |
|---|---|---|---|
| Mineral Oil | N/A | 0.5 | wt. % |

| | | | | |
|---|---|---|---|---|
| Density | 12-13 | lb/ft³ | 25-30 | lb/ft³ |

| | | |
|---|---|---|
| Total weight % | 100 | 100 |

1. A biodegradable animal litter comprising at least one pelletized wood substrate, at least one gum-based clumping agent and at least one adhering agent.

2. A biodegradable animal litter of claim 1, wherein said pelletized wood substrate is formed from wood shavings or chips that are derived from softwoods.

3. A biodegradable animal litter of claim 2, wherein said softwood is selected from Southern Yellow Pine, Lodgepole Pine and Cedar.

4. A biodegradable animal litter of claim 1, wherein said gum-based clumping agent is selected from galactomannan or an ether derivative thereof.

5. A biodegradable animal litter of claim 4, wherein said galactomannan gum is a guar gum or a locust bean gum.

6. A biodegradable animal litter of claim 1, wherein said adhering agent is selected from vegetable oil, soybean oil, mineral oil, diethylene glycol, triethylene glycol or propylene glycol.

7. A biodegradable animal litter of claim 6, wherein said adhering agent is mineral oil.

8. A biodegradable animal litter of claim 1, wherein said litter has a density of about 15 to about 45 lb/ft³.

9. A biodegradable animal litter of claim 8, wherein said litter has a density of about 25 to about 30 lb/ft³.

10. A biodegradable animal litter of claim 1, wherein said litter further includes an anionic polymer.

11. A biodegradable animal litter of claim 1, wherein said wood substrate is present in the amount of at least 75 wt. % of said litter, said gum-based clumping agent is present in the amount of about 3 to about 7 wt. % of said litter, and said adhering agent is present in the amount of about 0.1 to about 2.0 wt. % of said litter.

12. A biodegradable animal litter of claim 11, wherein said wood substrate is present in the amount of at least 90 wt. % of said litter, said gum-based clumping agent is present in the amount of about 4 to about 6 wt. % of said litter, and said adhering agent is present in the amount of about 0.2 to about 1.0 wt. % of said litter.

13. A biodegradable animal litter of claim 1, wherein said pellets have a particle size of −8 m to +40 m U.S. screen size.

14. A method for producing a biodegradable animal litter, wherein at least one wood substrate is heat treated, milled then pelletized, and said pellets are mixed with at least one gum-based clumping agent and at least one adhering agent.

15. A method of claim 14, wherein said litter has a density of about 25 to about 30 lb/ft³.

16. A method of claim 14, wherein said pellets have a particle size of −8 m to +40 m U.S. screen size.

17. A method of claim 14, wherein said wood substrate is formed from shavings of Southern Yellow Pine, Lodgepole Pine or Cedar.

18. A method of claim 14, wherein said gum-based clumping agent is selected from galactomannan or an ether derivative thereof.

19. A method of claim 14, wherein said adhering agent is selected from vegetable oil, soybean oil, mineral oil, diethylene glycol, triethylene glycol or propylene glycol.

20. A method of claim 14, wherein said wood substrate is present in the amount of at least 90 wt. % of said litter, said gum-based clumping agent is present in the amount of about 4 to about 6 wt. % of said litter, and said adhering agent is present in the amount of about 0.2 to about 1.0 wt. % of said litter.
